(19) United States
(12) Patent Application Publication
(10) Pub. No.: US 2003/0038993 A1
(43) Pub. Date: Feb. 27, 2003

(54) Automatic document-scanning method for scanner

(76) Inventors: Jen-Shou Tseng, Miao-Li Hsien (TW); Hsiu-O Hsu, Hsinchu (TW)

Correspondence Address: SUPREME PATENT SERVICES, POST OFFICE BOX 2339, SARATOGA, CA, 95070, US

(21) Appl. No.: 09/939,120

(22) Filed: Aug. 24, 2001

(51) Int. Cl. H04N 1/46

(52) U.S. Cl. 358/504

(57) ABSTRACT

An automatic document-scanning method for scanner is applicable to a document and comprises the following steps: (A) Previewing the document; (B) Performing optical character recognition of the written language on the document and calculating the deflection angle thereof; (C) Scanning the document; and (D) Automatically correcting the image of the scanned written language obtained in step (C) basing on the deflection angle. By above-mentioned method, even a slantingly misplaced document set on a document-loading panel of scanner can be properly amended in its orientation such that a normally oriented document image is providable to the scanner user.

### FIELD OF THE INVENTION

This invention relates to a document-scanning method, more particularly, it relates to an automatic document-scanning method for scanner that can scan to correct a slantingly misplaced document lying on a document-loading panel automatically so as to present a user with a duly oriented document image.

### BACKGROUND OF THE INVENTION

When using a scanner for scanning and input a document, a user is supposed to firstly lay the document on a document-loading panel of the scanner, then close a document cover and preview the document. If, at this moment, the document is found slantingly misplaced on the document-loading panel, the user has to re-lay the document on the panel correctly before he'll preview the document once more.

Abovesaid situation of a slantingly misplaced document may not be found and corrected in time if a scanner works in cooperation with an associated automatic document-feeding machine in the mode of scanning a plurality of documents simultaneously. The image of the misplaced documents must be checked, corrected, and scanned by manpower only, which is rather inconvenient in scanning operation.

### SUMMARY OF THE INVENTION

The primary object of this invention is to provide an automatic document-scanning method for scanner that can scan to automatically correct a slantingly misplaced document set on a document-loading panel so as to present a correctly oriented document.

In order to realize above-mentioned object, an automatic document-scanning method for scanner of this invention is applicable to a document and comprises the following steps: (A) Previewing the document; (B) Performing optical character recognition of the written language on the document and calculating the deflection angle thereof; (C) Scanning the document; and (D) Automatically correcting the image of the scanned written language obtained in step (C) basing on the deflection angle.

This invention further comprises a driver code programmed for the scanner, based on step (A) through step (D) for being run in a computer.

For more detailed information regarding advantages or features of this invention, at least an example of preferred embodiment will be elucidated below with reference to the annexed drawings.

### BRIEF DESCRIPTION OF THE DRAWINGS

The related drawings in connection with the detailed description of this invention to be made later are described briefly as follows, in which:

FIG. 1 shows a flowchart of this invention;

FIG. 2A is a schematic view showing that a method of this invention is embodied in form of a driver code and run in a computer;

FIG. 2B shows the state of the computer's main memory shown in FIG. 2A;

FIGS. 3A through 3C show the possible states of a document set on a document-loading panel of scanner; and

FIG. 3D is a schematic view showing the automatic document-misplacement correction made in FIG. 3A through FIG. 3C by the method of this invention.

### DETAILED DESCRIPTION OF THE INVENTION

A document-scanning method for scanner is capable of checking, finding, and correcting any possible misplacement of document set on a document-loading panel of scanner according to this invention.

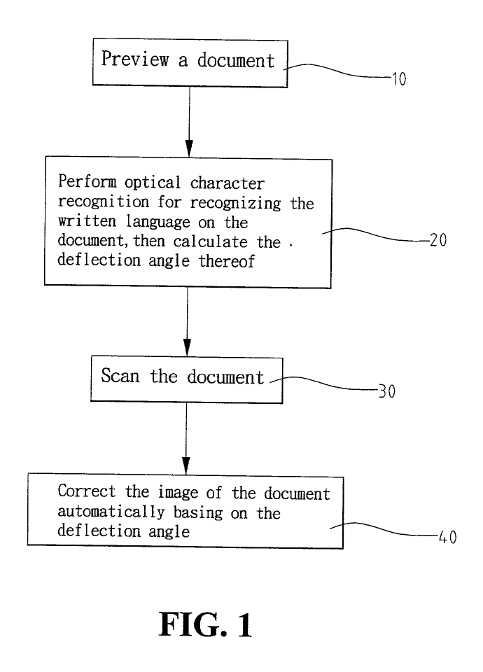

As indicated in a flowchart shown in FIG. 1, the procedure of the document-scanning method of this invention starts from step (10) to preview a document 100 which is preferable a document printed with written language. Step (20) is to perform an optical character recognition process for recognizing the written language on the document 100, then calculate the previewed deflection angle of the written language. Step (30) is to scan the document 100. Step (40) is to correct the orientation of the scanned image of the document 100 based on the deflection angle obtained in step (30).

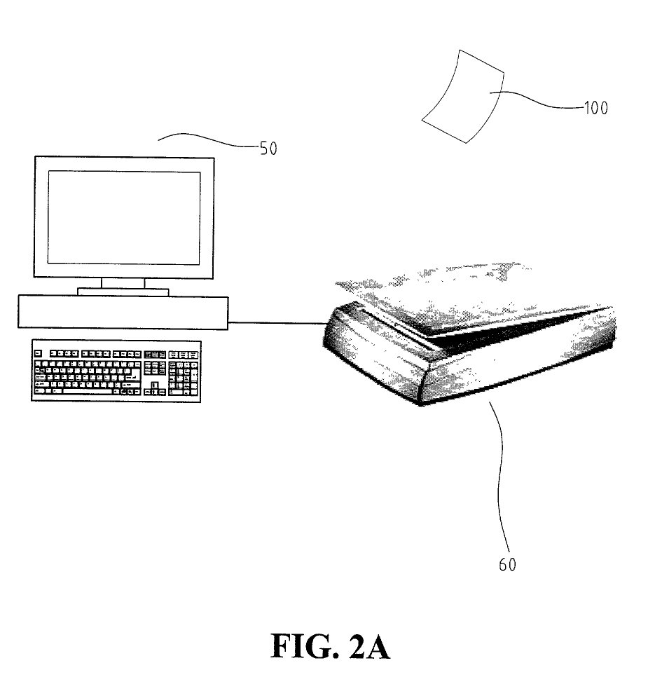

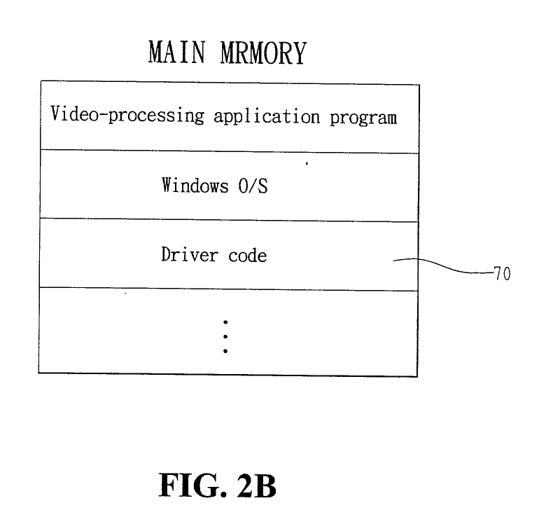

Step (10) through step (40) of this invention are conducted by a programmed driver code 70 shown in FIG. 2A—a schematic view showing a method of this invention being embodied in form of a driver code and run in a computer 50, which is connected with a scanner 60 for scanning the document 100. FIG. 2B shows the state of the computer's main memory shown in FIG. 2A. The main memory of the computer 50 stores at least a Windows O/S, a video-processing application program, and the driver code 70. After the document 100 has been set on a document-loading panel of the scanner 60, the computer 50 excutes a code in the driver code 70 for previewing the document, then the driver code 70 is to call a code for optical character recognition to recognize the written language on the document 100. After comparison of the recognized written language with that of the previewed, the driver code 70 is supposed to calculate the deflection angle of the previewed written language and scan the document 100, and finally, correct the image orientation of the document 100 based on the deflection angle. Therefore, in the case a document is slantingly misplaced on the document-loading panel of the scanner 60, the orientation of the document 100 can be properly amended after the driver code 70 is executed by the computer 50 for presenting a normally oriented document image to a scanner user.

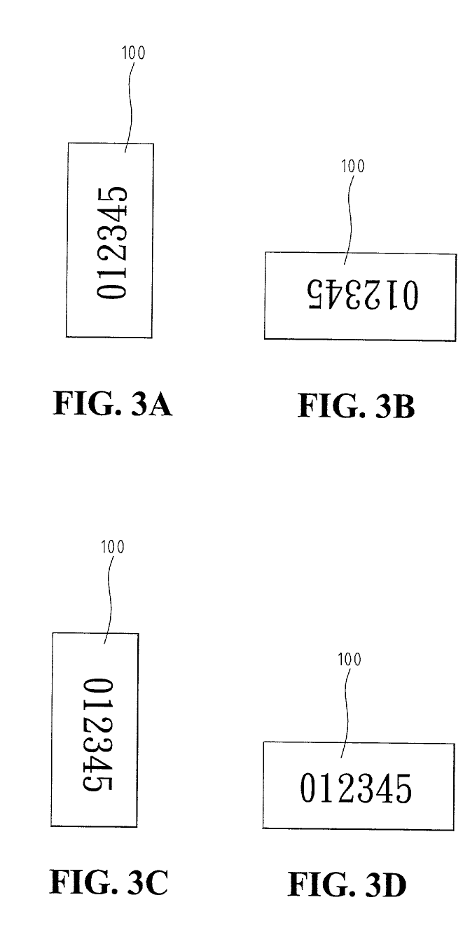

FIGS. 3A through 3C show the possible states of a document set on a document-loading panel of scanner and FIG. 3D is a schematic view showing the automatic document-misplacement correction made in FIG. 3A through FIG. 3C by the method of this invention. In FIGS. 3A, 3B, and 3C, the document 100 is slantingly misplaced by 90°, 180°, and 270° respectively. After execution of the driver code 70 by the computer 50, the respective slant angles are calculated and found as 90°, 180°, and 270°, which are then corrected as shown in FIG. 3D.

In the above described, at least one preferred embodiment has been described in detail with reference to the drawings annexed, and it is apparent that numerous variations or modifications may be made without departing from the true spirit and scope thereof, as set forth in the claims below.

What is claimed is:

1. An automatic document-scanning method for scanner applicable particularly to a document, comprising:
(A) Previewing the document;
(B) Performing optical character recognition of the written language on the document and calculating the deflection angle thereof;
(C) Scanning the document; and
(D) Automatically correcting the image of the scanned written language obtained in step (C) basing on the deflection angle.

2. The method according to claim 1, which further comprises a driver code programmed for the scanner, based on step (A) through step (D) for being run in a computer.
